(19) United States
(12) Patent Application Publication
(10) Pub. No.: US 2019/0315589 A1
(43) Pub. Date: Oct. 17, 2019

(54) WEB GUIDE ROLLER WITH RADIATION SHIELDING AT THE END FACE AND IRRADIATION APPARATUS

(71) Applicant: CROSSLINKING AB, Halmstad (SE)

(72) Inventors: BENGT LAURELL, HALMSTAD (SE); EBERHARD FOELL, NEHREN (DE)

(21) Appl. No.: 16/380,611

(22) Filed: Apr. 10, 2019

(30) Foreign Application Priority Data
Apr. 12, 2018 (DE) 102018003002.5

(51) Int. Cl. B65H 27/00; G21K 5/08; B65H 20/02

(52) U.S. Cl. CPC B65H 27/00; B65H 20/02; G21K 5/08

(57) ABSTRACT

A roller is described for an irradiation apparatus, wherein the roller is designed to guide a material web to be irradiated past at least one electron emitter. The roller comprises a first end face region of the roller, wherein the diameter of the first end face region is smaller than the diameter of the roller, and a jacket surface of the roller, which takes the form of a jacket surface of a right circular cylinder. The jacket surface extends in the axial direction from a first axial position to a second axial position of the roller, wherein the first axial position has an axial spacing from the edge of the first end face region which amounts to between 3% and 25% of the length of the roller, and wherein the second axial position is further away from the first end face region than the first axial position. The roller comprises a first curved transitional region, which extends from the edge of the first end face region annularly and continuously as far as the first axial position of the roller. Viewed in a longitudinal plane through the center axis of the roller, a curvature of the contour of the roller at the transition from the first end face region to the first curved transitional region, within the first curved transitional region and at the transition from the first curved transitional region to the jacket surface is in each case less than a maximum curvature which corresponds to a minimum radius of curvature of 5% of the diameter of the roller.

### FIELD OF THE INVENTION

The invention relates to a roller for an irradiation apparatus and to an irradiation apparatus for irradiating a material web with electrons. The invention further relates to a method for providing radiation shielding in an irradiation apparatus.

### BACKGROUND OF THE INVENTION

German patent application DE 10 2004 048 881 A1 describes an irradiation apparatus for irradiating a material web with electrons. To perform irradiation, the material web is guided over a web guide roller past the electron emitter, wherein the web guide roller is designed to absorb the impinging electrons and the resultant X-radiation.

### PROBLEM ADDRESSED BY THE INVENTION

The problem addressed by the invention is that of providing a roller for an irradiation apparatus, an irradiation apparatus and a method for providing radiation shielding, wherein shielding from high-energy radiation is improved in particular at the end face regions of the roller.

### SOLUTION ACCORDING TO THE INVENTION

The stated problem is solved by the provision of a roller for an irradiation apparatus, wherein the roller is designed to guide a material web to be irradiated past at least one electron emitter. The roller comprises a first end face region of the roller, wherein the diameter of the first end face region is smaller than the diameter of the roller, and a jacket surface of the roller, which takes the form of a jacket surface of a right circular cylinder. The jacket surface extends in the axial direction from a first axial position to a second axial position of the roller, wherein the first axial position has an axial spacing from the edge of the first end face region which amounts to between 3% and 25% of the length of the roller, and wherein the second axial position is further away from the first end face region than the first axial position. The roller has a first curved transitional region, which extends from the edge of the first end face region annularly and continuously as far as the first axial position of the roller. Viewed in a longitudinal plane through the center axis of the roller, a curvature of the contour of the roller at the transition from the first end face region to the first curved transitional region, within the first curved transitional region and at the transition from the first curved transitional region to the jacket surface is in each case less than a maximum curvature which corresponds to a minimum radius of curvature of 5% of the diameter of the roller.

The roller according to the invention is designed for use as a web guide roller and has a jacket surface configured as the jacket surface of a right circular cylinder. A material web to be irradiated may be guided over the jacket surface of the roller past an irradiation unit, which has one or more electron emitters for example. To this end, the roller is preferably mounted so as to rotate about an axis of rotation, wherein the axis of rotation is the center axis of the cylinder jacket of the jacket surface. According to the specific geometric configuration of the web guide roller, the first end face region has a smaller diameter than the jacket surface of the roller, such that the area of the first end face region is smaller than the cross-sectional area of the roller. The end face region of the roller is adjoined by an annular, convexly outwardly curved transitional region which extends as far as a first axial position. The first axial position has an axial spacing from the edge of the first end face region which amounts to between 3% and 25% of the length of the roller. The axial spacing is the distance in the axial direction between the edge of the first end-shaped region and the first axial position. The jacket surface of the roller begins at the first axial position and extends in the axial direction as far as a second axial position. In this respect, an annular, convexly outwardly curved transitional region is created by the transitional region between the end face region of the roller and the jacket surface of the roller, said annular transitional region producing a rounded transition between the end face region and the jacket surface. If the contour of the roller is viewed in a longitudinal plane passing through the center axis of the roller, then the contour assumes a curved course at the transition from the first end face region to the first transitional region, within the first curved transitional region and at the transition from the first transitional region to the jacket surface, wherein at each point of the contour the curvature is less than a predetermined maximum curvature value. A rounded course therefore results, wherein corners are avoided at the transition from the end face region to the jacket surface. At each point of the first transitional region the course is rounded. In this case, the maximum curvature corresponds to a minimum radius of curvature. If the contour of the roller at the transition from the first end face region to the first transitional region, within the first curved transitional region and at the transition from the first transitional region to the jacket surface is viewed in a longitudinal plane through the center axis of the roller, the respective radius of curvature is greater at each point of this contour than a predetermined minimum radius of curvature, wherein the predetermined minimum radius of curvature preferably amounts to 5% of the diameter of the jacket surface of the roller. In this way, a gently rounded course is obtained in the transitional region, wherein the radius of curvature preferably amounts at each point to more than 5% of the diameter of the jacket surface. Corners are thereby avoided at the end face end profile of the roller. By means of the convexly outwardly curved transitional region of the roller, effective shielding from high-energy radiation, in particular from X-radiation, can be achieved. Provision may for example be made for the outer contour of the roller to be surrounded by a complementarily shaped surface of the irradiation apparatus, such that a gap region forms between the outer surface of the roller and the complementary inner surface of the irradiation apparatus. High-energy radiation, in particular X-radiation, as arises for example in the event of irradiation with electrons, is repeatedly refracted within this gap region and in this way is effectively attenuated. In particular, the convexly outwardly curved course of the transitional region in this case forces repeated refraction of the radiation, so ensuring effective shielding.

Moreover, the stated problem is solved through provision of an irradiation apparatus for irradiating a material web with electrons. The irradiation apparatus comprises a rotatably mounted roller as described above for guiding a material web to be irradiated, and an irradiation unit with a receptacle which extends in the longitudinal direction of the roller and is designed to enclose a sub-portion of the roller, wherein at least one electron emitter is arranged within the receptacle which is designed to irradiate with electrons a material web guidable over the roller.

An irradiation apparatus according to the invention comprises a rotatably mounted roller as described above for guiding a material web to be irradiated. Furthermore, the irradiation apparatus comprises an irradiation unit with a receptacle which extends in the longitudinal direction of the roller and is designed to enclose a sub-portion of the roller, wherein at least one electron emitter is arranged within the receptacle which is designed to irradiate with electrons a material web guidable over the roller. With this irradiation apparatus, a sub-portion of the roller is accommodated within an axially extending receptacle, which encloses the sub-portion of the roller in the manner of a concave hollow shape. On rotation of the roller, the jacket surface of the roller and a material web guided by the roller is guided past the at least one electron emitter arranged in the receptacle and irradiated with electrons. In this case, the inner surface of the receptacle may be shaped such that it follows the convexly outwardly curved course of the transitional region of the roller.

A sub-region of the receptacle is preferably configured as a complementary shape to the convexly outwardly curved transitional region of the roller, such that a convexly curved gap region is formed between the inner surface of the receptacle and the transitional region of the roller, by which gap region the high-energy radiation, in particular X-radiation, generated on electron irradiation is severely reduced in its intensity by repeated refraction. The resultant curvedly configured gap region therefore enables effective radiation shielding to be achieved. In particular, the convexly curved transitional region also enables those X-rays to be intercepted which extend in an oblique direction relative to the axis of rotation of the roller. It has been found that a convexly outwardly curved shape of the end face end profile is superior to a stepped shape in the case of radiation shielding.

Moreover, the stated problem is solved through provision of an irradiation apparatus for irradiating a material web with electrons. The irradiation apparatus comprises a rotatably mounted roller for guiding a material web to be irradiated, wherein the roller comprises a first end face end profile at a first axial end of the roller and a jacket surface, wherein the jacket surface of the roller takes the form of a jacket surface of a right circular cylinder and extends from the first end face end profile in the axial direction of the roller. Furthermore, the irradiation apparatus comprises an irradiation unit with a receptacle, wherein the receptacle extends in the longitudinal direction of the roller and is designed to enclose a sub-portion of the roller, wherein at least one electron emitter is arranged within the receptacle which is designed to irradiate with electrons a material web guidable over the roller. In this case, the first end face end profile of the roller has a convexly curved region. The irradiation apparatus comprises a shielding block for radiation shielding, wherein the shielding block has a bearing surface via which the shielding block may be fastened detachably to a mounting surface of the irradiation unit. Moreover, the shielding block has a depression provided in the shielding block, wherein at least one sub-region of the depression is configured as a negative hollow shape relative to at least one sub-region of the convexly curved region.

The irradiation apparatus comprises the roller and an irradiation unit with a receptacle enclosing a sub-portion of the roller. A material web to be irradiated is guided by means of the roller past at least one electron emitter arranged in the receptacle and irradiated with electrons. On electron emission, high-energy X-radiation arises in particular in the interspace between the roller surface and the receptacle. To shield this X-radiation arising in the arcuate gap between roller and receptacle, a shielding block is used which is fastened detachably by its bearing surface to a mounting surface of the irradiation unit. The shielding block has any desired geometric basic shape and has a depression which receives the end face end profile of the roller at least in part when the shielding block is mounted on the intended mounting surface of the irradiation unit. The X-radiation which arises in the arcuate interspace between the roller and the receptacle enclosing the roller may in particular be shielded by means of the shielding block. In this case, the inner wall of the depression may preferably follow the course of the end face end profile in such a way that the radiation is repeatedly refracted and effective radiation shielding is thus achievable. A curved gap region is preferably formed between the end face end profile and the depression. Shielding the X-radiation exiting from the arcuate gap by means of a shielding block has the advantage that the shielding block may be simply placed with its depression onto the end face end profile of the roller and onto the mounting surface of the irradiation unit and fastened detachably there. Assembly and disassembly of the irradiation apparatus is therefore simplified. Provision may moreover also be made for the position of the shielding block relative to the roller to be adjustable. For example, the gap region between the end face end profile of the roller and the inner surface of the depression may be adjusted to achieve the best possible radiation shielding. The removable shielding blocks simplify assembly and maintenance of the irradiation apparatus.

A method according to the invention serves to provide radiation shielding in an irradiation apparatus. The irradiation apparatus comprises a rotatably mounted roller for guiding a material web to be irradiated, wherein the roller comprises a first end face end profile at a first axial end of the roller and a jacket surface, wherein the first end face end profile comprises a convexly curved region, wherein the jacket surface of the roller takes the form of a jacket surface of a right circular cylinder and extends from the first end face end profile in the axial direction of the roller. Furthermore, the irradiation apparatus comprises an irradiation unit with a receptacle, wherein the receptacle extends in the longitudinal direction of the roller and is designed to enclose a sub-portion of the roller, wherein at least one electron emitter is arranged within the receptacle which is designed to irradiate with electrons a material web guidable over the roller. Furthermore, the irradiation apparatus comprises a shielding block for radiation shielding. The shielding block has a bearing surface via which the shielding block may be fastened detachably to a mounting surface of the irradiation unit. The shielding block additionally has a depression provided in the shielding block. The method comprises a step of mounting the shielding block on a mounting surface of the irradiation unit in such a manner that at least one part of the first end face end profile of the roller extends into the depression of the shielding block, wherein at least one sub-region of the depression takes the form of a negative hollow shape relative to at least one sub-region of the convexly curved region.

### PREFERRED EMBODIMENTS OF THE INVENTION

Advantageous developments and further developments, which may be used individually or in combination, constitute the subject matter of the dependent claims and the following description.

### ROLLER FOR AN IRRADIATION APPARATUS

Preferably, viewed in a longitudinal plane through the center axis of the roller, a slope of the contour of the roller at the transition from the first end face region to the first curved transitional region, within the first curved transitional region and at the transition from the first curved transitional region to the jacket surface is in each case continuous.

Preferably, if the outer contour of the roller is viewed in the axial direction of the roller, from the center of the roller towards an end face, the diameter of the outer contour of the roller remains the same or becomes smaller.

Preferably, viewed in a longitudinal plane through the center axis of the roller, a slope of the contour of the roller at the transition from the first end face region to the first curved transitional region, within the first curved transitional region and at the transition from the first curved transitional region to the jacket surface in each case falls monotonically or rises monotonically.

Preferably, viewed in a longitudinal plane through the center axis of the roller, the sign of the curvature of the contour of the roller at the transition from the first end face region to the first curved transitional region, within the first curved transitional region and at the transition from the first curved transitional region to the jacket surface remains unchanged.

Preferably, viewed in a longitudinal plane through the center axis of the roller, the contour of the roller within the first curved transitional region has a curvature at each point of the contour which corresponds to a radius of curvature in the range between 5% and 40% of the diameter of the jacket surface of the roller.

Preferably, viewed in a longitudinal plane through the center axis of the roller, a curvature of the contour of the roller at the transition from the first end face region to the first curved transitional region, within the first curved transitional region and at the transition from the first curved transitional region to the jacket surface is at each point of the contour less than a maximum curvature which is equal to the reciprocal of a radius of curvature of 5% of the diameter of the jacket surface of the roller.

Preferably, viewed in a longitudinal plane through the center axis of the roller, the contour of the roller within the first curved transitional region has a curvature at each point of the contour which lies within a range which is given by reciprocals of the radius of curvature in the range from 5% to 40% of the diameter of the jacket surface of the roller.

Preferably, the curvature within the first transitional region is given by a single radius of curvature, wherein this radius of curvature lies in the range between 5% and 40% of the diameter of the jacket surface of the roller.

Preferably, the curvature extends continuously within the first curved transitional region.

Preferably, the roller has a second end face region which, when viewed in the axial direction, is arranged opposite the first end face region, wherein the second end face region of the roller has a diameter which is smaller than the diameter of the roller, wherein the second axial position of the roller has an axial spacing from the edge of the second end face region which amounts to between 5% and 25% of the length of the roller, wherein the roller has a second curved transitional region, which extends from the edge of the second end face region annularly and continuously as far as the second axial position of the jacket surface, wherein, viewed in a longitudinal plane through the center axis of the roller, a slope of a contour of the roller at the transition from the second end face region to the second curved transitional region, within the second curved transitional region and at the transition from the second curved transitional region to the jacket surface is in each case continuous, and viewed in a longitudinal plane through the center axis of the roller, a curvature of the contour of the roller within the second curved transitional region is smaller at each point of the contour than a maximum curvature which corresponds to a minimum radius of curvature of 5% of the diameter of the roller.

Preferably, the first end face region is configured to be rotationally symmetrical relative to the center axis of the roller.

Preferably, the second end face region is configured to be rotationally symmetrical relative to the center axis of the roller.

Preferably, the first end face region takes the form of the first end surface of the roller, which is perpendicular to the center axis of the roller.

Preferably, the second end face region takes the form of the second end surface of the roller, which is perpendicular to the center axis of the roller.

Preferably, the center axis of the roller takes the form of the axis of rotation of the roller.

Preferably, the first curved transitional region is configured to be rotationally symmetrical relative to a center axis of the roller.

Preferably, the first curved transitional region is configured as a convexly outwardly curved transitional region.

Preferably, the first curved transitional region is an annularly peripheral, convexly outwardly curved transitional region.

Preferably, the first end face region has a radius which amounts to between 30% and 47% of the diameter of the roller.

Preferably, the second end face region has a radius which amounts to between 30% and 47% of the diameter of the roller.

Preferably, the roller takes the form of a rotationally symmetrical component.

Preferably, the roller is configured to be rotationally symmetrical about an axis of rotation of the roller.

Preferably, the roller is a cooling roll for an electron irradiation apparatus.

Preferably, the roller is a web guide roller.

Preferably, the roller is a web guide roller for an electron irradiation apparatus.

Preferably, radiation shielding of radiation-shielding material is arranged at the jacket surface or within the jacket surface for the purpose of shielding from high-energy radiation.

Preferably, radiation shielding in the form of a cylinder jacket of radiation-shielding material is arranged at the jacket surface or within the jacket surface for the purpose of shielding from high-energy radiation.

Preferably, the jacket surface of the roller has a diameter of more than 15 cm.

Preferably, the jacket surface of the roller has a diameter of less than 155 cm.

Preferably, the roller has a length of between 40 cm and 3.80 m from the first end face region to the second end face region.

Preferably, the roller is designed to guide material webs with a width of between 15 cm and 3.50 m.

Preferably, the jacket surface of the roller has a length of between 20 cm and 3.60 m.

### IRRADIATION APPARATUS WITH ROTATABLY MOUNTED ROLLER

Preferably, an inner wall of the receptacle facing the roller follows the course, at least in a sub-region, of the first curved transitional region of the roller.

Preferably, an inner wall of the receptacle facing the roller follows the course, at least in a sub-region, of the first curved transitional region of the roller, wherein a gap region is formed between the inner wall of the receptacle and the first curved transitional region.

Preferably, an inner wall of the receptacle facing the roller follows the course, at least in a sub-region, of the first curved transitional region of the roller, wherein a gap region is formed between the inner wall of the receptacle and the first curved transitional region, wherein the gap region is dimensioned so as to achieve effective radiation shielding.

Preferably, an inner wall of the receptacle facing the roller has a shape, at least in a sub-region, complementary to the first curved transitional region of the roller.

Preferably, the first curved transitional region of the roller is surrounded at least in part by the receptacle, which has a shape, at least in a sub-region, complementary to the first curved transitional region.

Preferably, at least one sub-region of the receptacle is configured as a negative hollow shape relative to at least one sub-region of the first curved transitional region of the roller.

Preferably, the roller has a first end face end profile at the first axial end of the roller which encompasses the first end face region and the first curved transitional region.

Preferably, if the outer contour of the roller is followed in the axial direction from the center of the roller towards an end face, the diameter of the outer contour of the roller remains the same or becomes smaller when viewed in the axial direction.

Preferably, an inner wall of the receptacle facing the roller follows the course, at least in a sub-region, of the first end face end profile of the roller.

Preferably, an inner wall of the receptacle facing the roller follows the course, at least in a sub-region, of the first end face end profile of the roller, wherein a gap region is formed between the inner wall of the receptacle and the first end face end profile of the roller.

Preferably, an inner wall of the receptacle facing the roller follows the course, at least in a sub-region, of the first end face end profile of the roller, wherein a gap region is formed between the inner wall of the receptacle and the first end face end profile of the roller, wherein the gap region is dimensioned so as to achieve effective radiation shielding.

Preferably, an inner wall of the receptacle facing the roller has a shape, at least in a sub-region, complementary to the first end face end profile of the roller.

Preferably, the first end face end profile is enclosed at least in part by the complementarily shaped receptacle.

Preferably, the first end face end profile of the roller is enclosed at least in part by the receptacle which has a shape, at least in a sub-region, complementary to the first end face end profile.

Preferably, at least one sub-region of an inner wall of the receptacle facing the roller is configured as a negative hollow shape relative to at least one sub-region of the first end face end profile of the roller.

Preferably, the receptacle has an arcuate profile transversely of the center axis of the roller, wherein the arcuate profile of the receptacle is designed to enclose a sub-portion of the roller.

Preferably, the at least one electron emitter extends in the axial direction along a region of the receptacle facing the roller.

Preferably, the receptacle is a concavely shaped receptacle.

Preferably, the roller is mounted rotatably about a center axis, which takes the form of the axis of rotation.

Preferably, radiation shielding surrounding the at least one electron emitter is provided within the irradiation unit.

Preferably, at least one mounting surface of the irradiation unit extends substantially in a plane perpendicular to the center axis of the roller.

Preferably, the irradiation apparatus comprises a shielding block for radiation shielding, wherein the shielding block has: a bearing surface, via which the shielding block may be detachably fastened to a mounting surface of the irradiation unit, a depression provided in the shielding block, wherein at least one sub-region of the depression is configured as a negative hollow shape relative to at least one sub-region of the first curved transitional region of the roller.

### IRRADIATION APPARATUS WITH AT LEAST ONE SHIELDING BLOCK

Preferably, the depression follows the course, at least in a sub-region, of the convexly curved region.

Preferably, the depression follows the course, at least in a sub-region, of the convexly curved region, wherein a gap region is formed between the depression and the convexly curved region.

Preferably, the depression follows the course, at least in a sub-region, of the convexly curved region, wherein a gap region is formed between the depression and the convexly curved region, wherein the gap region is dimensioned so as to achieve effective radiation shielding.

Preferably, the depression has a shape, at least in a sub-region, complementary to the convexly curved region.

Preferably, the convexly curved region is surrounded at least in part by the depression, which has a shape, at least in a sub-region, complementary to the convexly curved region.

Preferably, the depression is designed to enclose the first end face end profile of the roller at least in part when the shielding block is fastened to the mounting surface.

Preferably, the depression follows the course, at least in a sub-region, of the first end face end profile of the roller.

Preferably, the depression follows the course, at least in a sub-region, of the first end face end profile of the roller, wherein a gap region is formed between the inner wall of the depression and the first end face end profile of the roller.

Preferably, the depression follows the course, at least in a sub-region, of the first end face end profile of the roller, wherein a gap region is formed between the inner wall of the depression and the first end face end profile of the roller, wherein the gap region is dimensioned so as to achieve effective radiation shielding.

Preferably, the depression follows the course, at least in a sub-region, of the first end face end profile of the roller, wherein a gap region is formed between the inner wall of the depression and the first end face end profile of the roller, wherein the gap region has a substantially uniform gap width.

Preferably, the depression has a shape, at least in a sub-region, complementary to the first end face end profile of the roller.

Preferably, the depression is configured as a negative hollow shape relative to at least one sub-region of the first end face end profile of the roller.

Preferably, the first end face end profile of the roller is enclosed at least in part by the complementarily shaped depression when the shielding block is fastened to the mounting surface.

Preferably, the depression is designed to accommodate at least one part of the first end face end profile of the roller when the shielding block is fastened to the mounting surface.

Preferably, the depression is configured such that, when the shielding block is fastened to the mounting surface, at least one part of the first end face end profile of the roller extends into the depression.

Preferably, the irradiation apparatus has at least one further shielding block.

Preferably, the first end face end profile of the roller has a rotationally symmetrically shaped outer surface.

Preferably, the first end face end profile of the roller is of rotationally symmetrical configuration.

Preferably, the convexly curved region is an annularly peripheral, convexly outwardly curved region of the first end face end profile.

Preferably, the convexly curved region is an annularly peripheral, convexly outwardly curved region of the first end face end profile which is rotationally symmetrical relative to the axis of rotation of the roller.

Preferably, the first end face end profile comprises the convexly curved region and a first end face region of the roller.

Preferably, the first end face end profile comprises the convexly curved region and a first end face region of the roller, wherein the convexly curved region forms a transition from the first end face region of the roller to the jacket surface of the roller.

Preferably, if the outer contour of the roller is viewed in the axial direction of the roller, from the center of the roller towards an end face, the diameter of the outer contour of the roller remains the same or becomes smaller.

Preferably, in the axial direction opposite the first end face end profile, a second end face end profile is arranged at a second axial end of the roller and the jacket surface of the roller extends axially from the first end face end profile to the second end face end profile.

Preferably, the roller is a roller as described above.

Preferably, the irradiation apparatus comprises a roller frame, in which the roller is rotatably mounted.

Preferably, the irradiation apparatus comprises a roller frame, in which the roller is rotatably mounted, wherein the roller frame with the roller and the irradiation unit are movable relative to one another.

Preferably, the irradiation apparatus comprises a roller frame, in which the roller is rotatably mounted, wherein the roller frame with the roller and the irradiation unit are movable relative to one another, wherein the irradiation unit is movable relative to the roller frame into an open position and into a closed position, wherein in the closed position the at least one electron emitter is positioned in such a way relative to the roller that a material web guided over the roller may be irradiated, and wherein in the open position access is enabled to the roller.

Preferably, a notch encircling part of the roller is formed on a mounting surface of the irradiation unit at the region facing the roller.

Preferably, a notch encircling part of the roller is formed on a mounting surface of the irradiation unit at the region facing the roller, wherein one or more arcuate sheets may be inserted into the notch.

Preferably, a notch encircling part of the roller is formed on a mounting surface of the irradiation unit at the region facing the roller, wherein a stack of multiple arcuate sheets may be inserted one above the other into the notch.

Preferably, a notch encircling part of the roller is formed on a mounting surface of the irradiation unit at the region facing the roller, wherein one or more arcuate sheets may be inserted into the notch, wherein the one or more arcuate sheets are configured to provide a gas seal between the irradiation unit and the roller.

Preferably, the shielding block is formed at least in part from a radiation-shielding material.

Preferably, shielding inserts made of a shielding material are arranged within the shielding block.

Preferably, recesses extend from the depression of the shielding block into the interior of the shielding block, into which recesses shielding inserts of a shielding material may be inserted or into which molten shielding material may be introduced.

Preferably, the shielding block is constructed from a plurality of axially successive plate elements, wherein at least one plate element has one or more recesses for one or more shielding inserts.

Preferably, the mounting surface of the irradiation unit extends substantially in a plane which is inclined by an angle of between 0° and 60° relative to a plane perpendicular to the center axis of the roller.

Preferably, the mounting surface of the irradiation unit extends substantially in a plane perpendicular to the center axis of the roller.

Preferably, when the shielding block is fastened to the mounting surface of the irradiation unit, the bearing surface of the shielding block extends in the direction predetermined by the mounting surface of the irradiation unit.

Preferably, when the shielding block is fastened to the mounting surface of the irradiation unit, the bearing surface of the shielding block extends in a plane perpendicular to the center axis of the roller.

Preferably, viewed in the direction of the center axis of the roller, the shielding block covers at least part of the cross-section of the roller.

Preferably, viewed in the direction of the center axis of the roller, the shielding block covers at least 30% of the cross-section of the roller.

Preferably, viewed in the direction of the center axis of the roller, the shielding block covers at least 50% of the cross-section of the roller.

Preferably, viewed in the direction of the center axis of the roller, the shielding block covers a gap between the roller and the receptacle of the irradiation unit.

Preferably, the shielding block is fastenable detachably by means of fastening elements to a mounting surface of the irradiation unit.

Preferably, the shielding block is fastenable detachably by means of fastening elements to a mounting surface of the irradiation unit, wherein a spacing between the first end face end profile of the roller and the inner wall of the depression is adjustable by means of the fastening elements.

Preferably, the shielding block is fastenable detachably by means of fastening elements to a mounting surface of the irradiation unit, wherein the position of the shielding block relative to the mounting surface is adjustable by means of the fastening elements.

### BRIEF DESCRIPTION OF THE DRAWINGS

Further advantageous configurations are described in greater detail below with reference to multiple exemplary embodiments illustrated schematically in the drawings, to which the invention is however not limited and in which:

FIG. 1a shows an irradiation apparatus comprising a web guide roller and an irradiation unit, in a closed position;

FIG. 1b shows the irradiation apparatus of FIG. 1a in an open position;

FIG. 2 shows a longitudinal section through the roller and the irradiation unit;

FIG. 3 shows a cross-section through the roller and the irradiation unit;

FIG. 4 shows a longitudinal section through a roller and an irradiation unit according to the prior art;

FIG. 5 shows a cross-section through the roller and the irradiation unit of FIG. 4;

FIG. 6 shows a longitudinal section through the entire roller, wherein the longitudinal section extends through the center axis of the roller;

FIG. 7a shows the detachable mounting of two shielding blocks on the side walls of the irradiation unit;

FIG. 7b shows the irradiation apparatus in the fully assembled state;

FIG. 8 shows an oblique view of a shielding block, which has a depression for accommodating a part of the end face inner profile of the roller.

### DETAILED DESCRIPTION OF EMBODIMENTS OF THE INVENTION

In the description given below of preferred embodiments of the present invention, the same reference signs denote the same or comparable components.

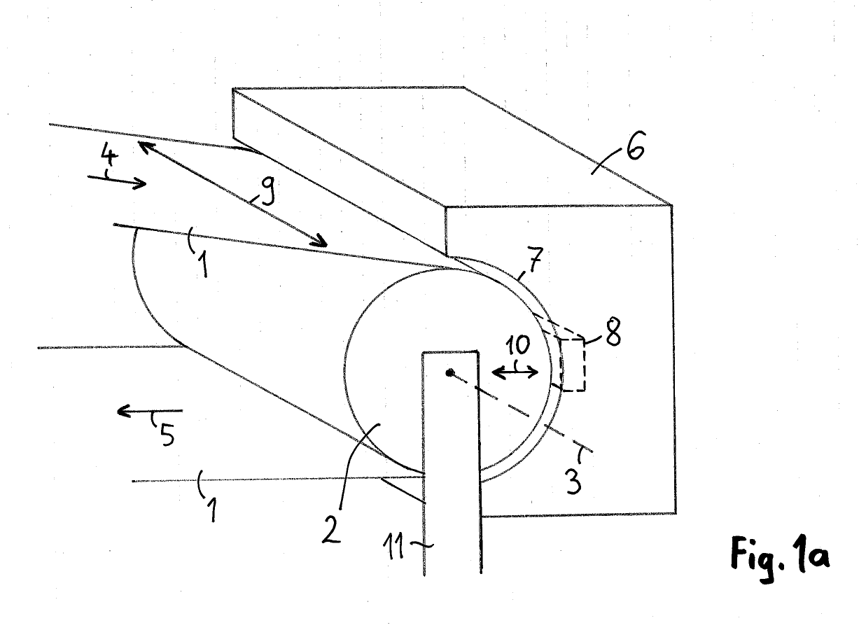

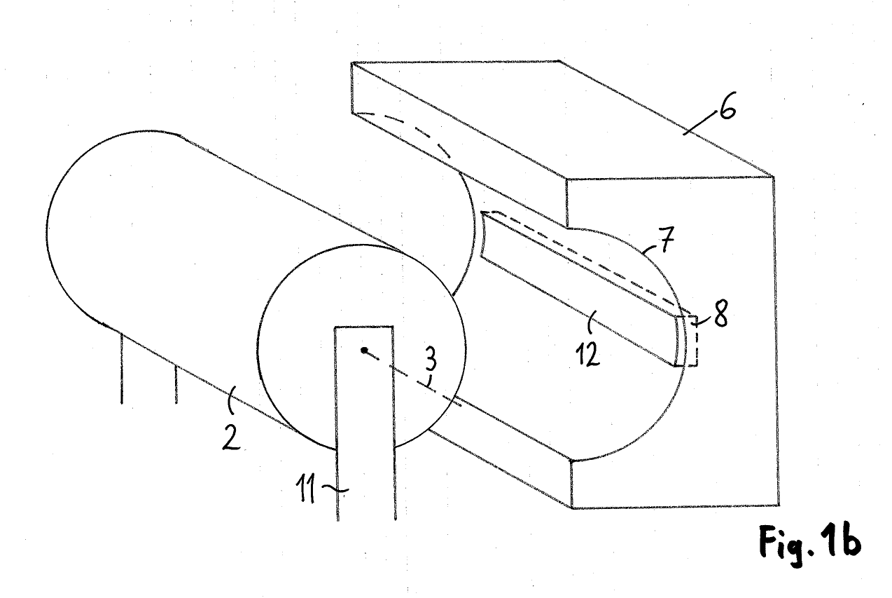

FIG. 1a shows an irradiation apparatus for irradiating a material web 1 with electrons, wherein the irradiation apparatus has an open roller guide. The irradiation apparatus comprises a roller 2, which is mounted to rotate about a longitudinally extending axis of rotation 3. The material web 1 may be guided in the direction of arrows 4 and 5 through the irradiation apparatus over the jacket surface of the roller 2. The irradiation apparatus comprises an irradiation unit 6 with a receptacle 7 for the roller 2. The receptacle 7 extends in the longitudinal direction of the roller 2 and encloses a portion of the jacket surface of the roller 2. In this case, the receptacle 7 partly encloses the roller 2, wherein the inner surface of the receptacle 7 is complementary in shape to the jacket surface of the roller 2, a gap being formed between the roller 2 and the receptacle 7. In this respect, the inner surface of the receptacle 7 takes the form of a portion of a cylinder jacket with a somewhat larger diameter than the diameter of the roller 2. The inner surface of the receptacle 7 surrounds the jacket surface of the roller 2 over a given angle α, wherein the angle α amounts in the example of FIG. 1a to around 180°. The angle α is preferably greater than 90°, more preferably greater than 135°. The angle α is preferably less than 270°, more preferably less than 225°. When viewed in a transverse plane perpendicular to the axis of rotation 3, the receptacle 7 takes a circular arc-shaped course. The irradiation unit 6 comprises at least one electron emitter 8 for generating electrons with an energy in the range from around 100 to 300 keV, wherein the at least one exit window of the at least one electron emitter 8 is arranged in the inner surface of the receptacle 7. The electron exit window(s) of the at least one electron emitter 8 preferably extend(s) in the longitudinal direction of the roller 2. At the same time, the at least one electron emitter 8 is designed to be able to irradiate as far as possible the entire width 9 of the material web 1 with electrons.

The web 1 may for example be a web of paper or paperboard, a plastics film, a metal foil, a laminate material, a printed material web etc. The width 9 of the material web 1 preferably lies in the range between 15 cm and 3.50 m. To be able to guide the material web 1 through the irradiation apparatus, the jacket surface of the roller 2 has a length of between 20 cm and 3.60 m, wherein the roller 2 has a length, from the first to the second end face, of between for example 40 cm and 3.80 m. The length of the roller 2 is thus selected to be somewhat greater than the width of the material web to be irradiated. The roller preferably has a diameter of more than 15 cm. The roller preferably has a diameter of less than 155 cm.

If the roller 2 rotates about the axis of rotation 3, the material web 1 is introduced into the irradiation apparatus in the direction of arrow 4. The material web 1 is guided over the jacket surface of the roller 2 through the receptacle 7 and in the process is irradiated with electrons generated by the at least one electron emitter 8. The irradiated material web is guided out of the irradiation apparatus at the bottom of the receptacle 7 in the direction of arrow 5. To achieve good irradiation results, the gap between the surface of the roller 2 and the inner surface of the receptacle 7 is preferably evacuated or filled with an inert gas such as for example argon.

The open roller guide shown in FIG. 1a offers a series of advantages. One important advantage is that the web surface remains accessible and may be inspected during ongoing operation. If problems occur, the roller frame of the roller 2 and the irradiation unit 6 may be displaced relative to one another in the direction of double-headed arrow 10 after the at least one electron emitter 8 has been switched off. In this way, the irradiation apparatus is transferred into the opened position shown in FIG. 1b, in which the irradiation unit 6 with the at least one electron emitter 8 is arranged spaced relative to the roller 2 and relative to the roller frame 11 supporting the roller. In the opened state of the irradiation apparatus, the material web 1 can be inspected and readjusted; moreover, access to the at least one electron exit window 12 of the at least one electron emitter 8 is possible. The open roller structure therefore enables simplified maintenance and convenient operation of the irradiation apparatus. Furthermore, the interaction between the roller 2 and the receptacle 7 partly enclosing the roller enables effective radiation shielding of the X-radiation arising.

During irradiation of the material web 1 with accelerated electrons, the accelerated electrons are decelerated as they impinge on the material web 1 of the roller 2 or of the receptacle 7 enclosing the roller 2, wherein secondary X-radiation arises on deceleration of the electrons. The open roller structure shown in FIG. 1a, in which the roller 2 is enclosed over a given angular range of its cross-section by the receptacle 7, in this case serves as radiation shielding. To this end, a radiation-shielding material such as for example lead, which absorbs the X-radiation which arises and provides the necessary radiation shielding, is integrated into the roller 2 at or below the jacket surface of the roller 2. Furthermore, the receptacle 7 is also lined on its inner surface with radiation-absorbing material such as for example lead, such that impinging X-radiation is shielded and cannot leak out. However, X-radiation may exit at the end faces of the irradiation apparatus from the gap between the receptacle 7 and the surface of the roller 2. To protect operators, it is therefore necessary, in addition to the radiation shielding of the roller surface and the receptacle 7, to provide further radiation shielding at the end faces of the irradiation apparatus at the arcuate roller gap. It will be described below how such radiation shielding may be implemented at the end faces of the irradiation apparatus.

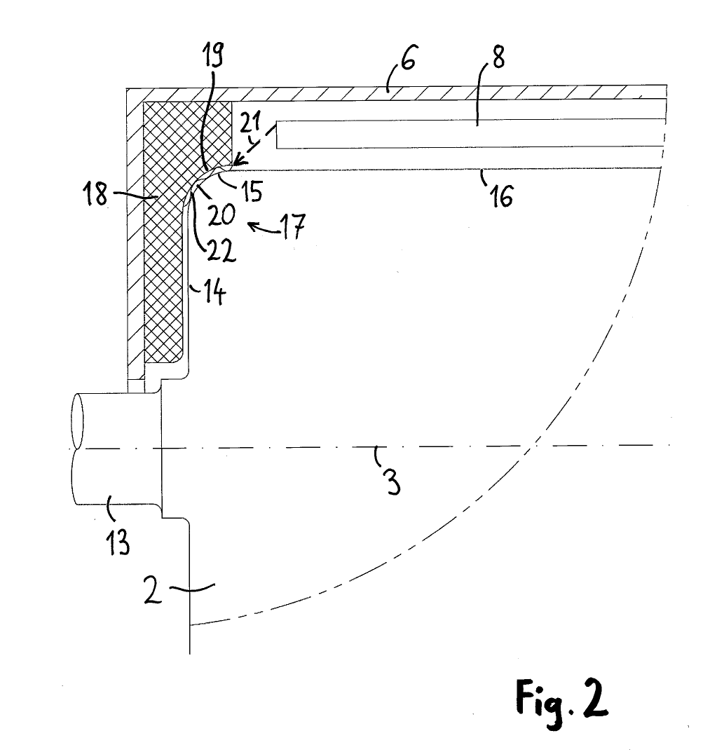

FIG. 2 shows radiation shielding for the arcuate roller gap according to the embodiments of the invention. To this end, FIG. 2 shows a longitudinal section through the roller 2, wherein the section runs through the axis of rotation 3. The sectional representation of FIG. 2 also reveals an electron emitter 8. The roller 2 is driven by a drive shaft 13, which sets the roller 2 in rotational motion about the axis of rotation 3. The roller 2 has an end surface 14, which extends substantially perpendicular to the axis of rotation 3. A convexly curved, rotationally symmetrically configured transitional region 15 adjoins the end surface 14 and forms a curved transition between the end surface 14 and the jacket surface 16. In this respect, the end face end profile 17 of the roller 2 encompasses both the end surface 14 and the curved transitional region 15.

To provide radiation shielding, an end face shielding block 18 is mounted detachably on the irradiation unit 6, which block has a depression 19, wherein the end face end profile 17 of the roller 2 extends into the depression 19. In this case, the inner surface of the depression 19 is configured to be complementary in shape to the end surface 14 and the curved transitional region 15. If the end face end profile 17 extends into the depression 19 and is encompassed by the depression 19, a comparatively narrow gap region 20 is formed between the end face end profile 17 and the complementarily shaped depression 19. The gap region 20 preferably has a gap width of more than 1 mm, more preferably of more than 3 mm. The gap region 20 preferably has a gap width of less than 10 mm, more preferably of less than 7 mm. The gap region 20 serves to shield the X-radiation arising during electron irradiation. If the X-radiation enters the gap region 20 between the end face shielding block 18 and the end face end profile 17 in the direction of arrow 21, the X-radiation is repeatedly refracted within the gap region 20 and thereby attenuated such that no X-radiation can leak out. Marked attenuation of the X-radiation is then achieved, in particular between the curved transitional region 15 and the depression 19 complementary in shape thereto.

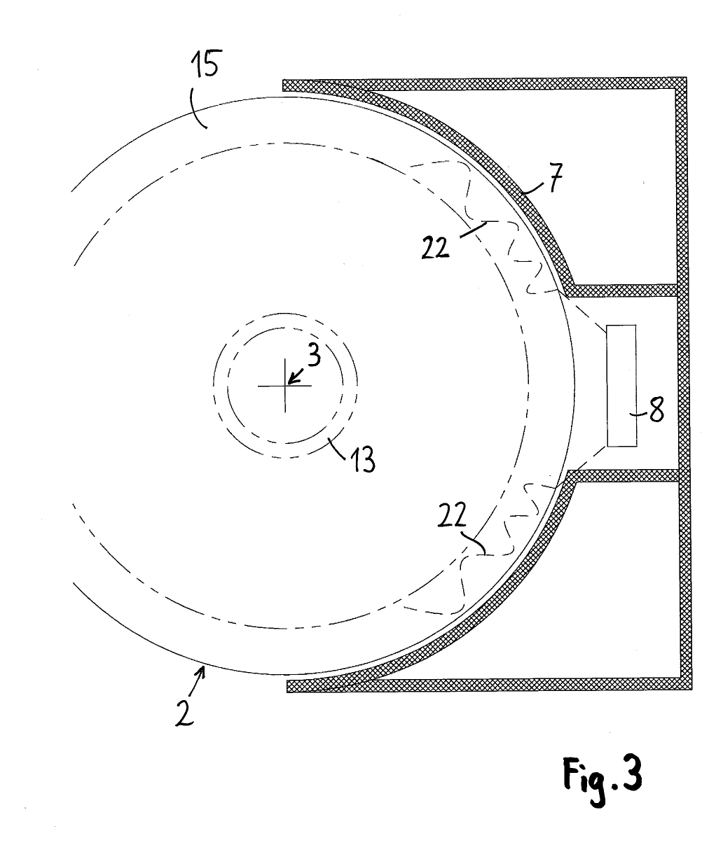

In FIG. 3 the roller 2 and the irradiation unit 6 are shown in cross-section, wherein the shielding according to the invention of the X-radiation is apparent at the end face of the roller 2. In the cross-section of FIG. 3, the roller 2 is apparent, with the drive shaft 13 and the axis of rotation 3. Moreover, FIG. 3 shows the receptacle 7 and the at least one electron emitter 8, wherein the receptacle 7 partly encloses the jacket surface of the roller 2. On deceleration of electrons generated by the at least one electron emitter 8, X-radiation arises, which enters the gap region 20 and is then repeatedly refracted in accordance with the dashed path 22 between the curved transitional region 15 of the roller 2 and the depression 19 of the end face shielding block 18 and thereby markedly attenuated.

In this case, effective shielding of the X-radiation is achieved precisely through the interaction of the convexly curved transitional region 15 with the concave curvature complementary thereto of the depression 19.

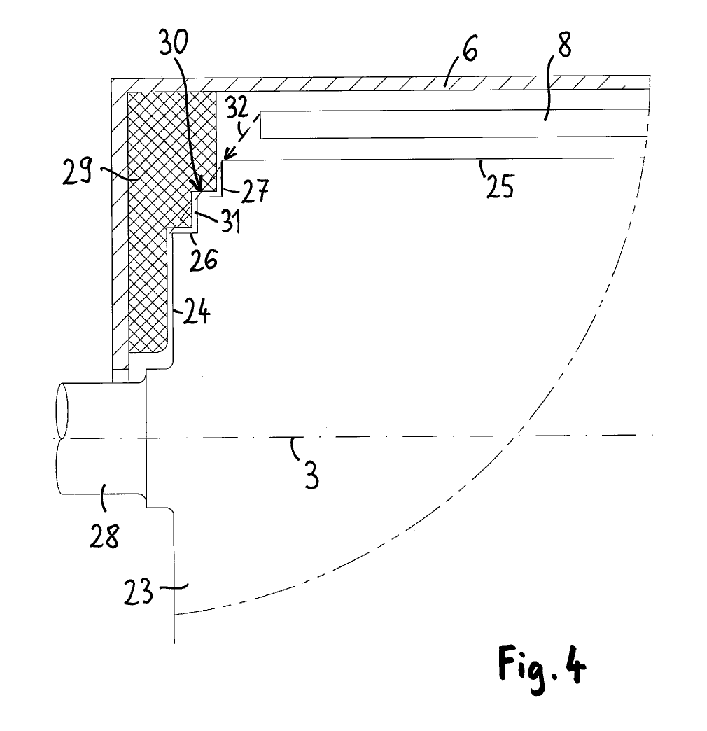

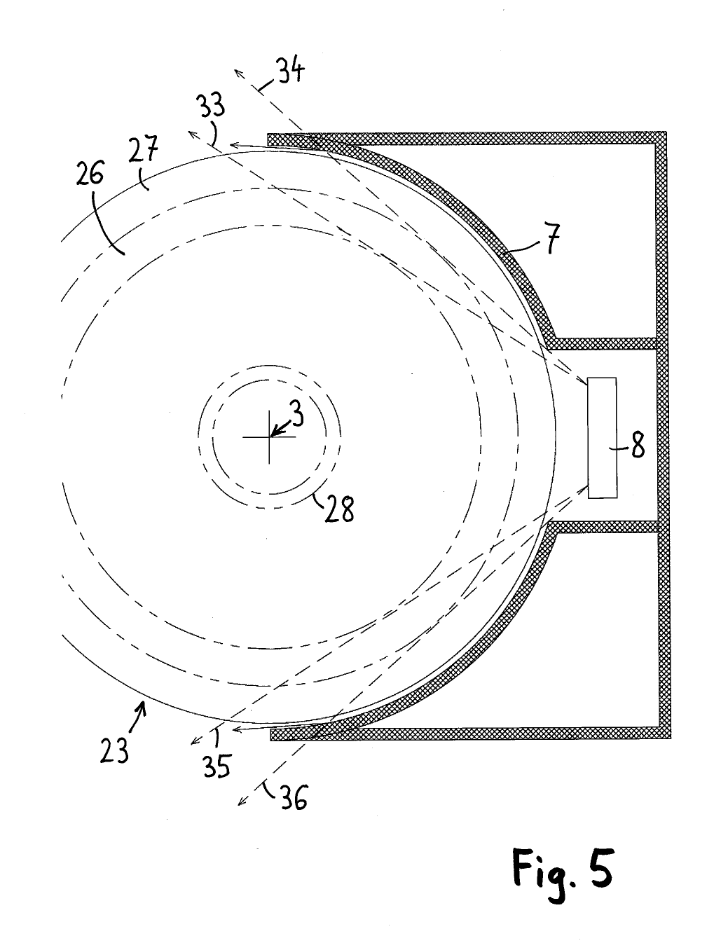

This is clear in particular from a comparison with the example shown in FIG. 4. FIG. 4 shows a roller 23, in which multiple peripheral steps are provided for radiation shielding in the transitional region between the end surface 24 and the jacket surface 25, for example one, two, three or four peripheral steps. In the example of FIG. 4 two peripheral steps are provided, a first peripheral step 26 and a second peripheral step 27. The roller 23 may rotate about the axis of rotation 3, wherein the roller 23 is driven via the drive shaft 28. For radiation shielding purposes, the irradiation unit 6 comprises an end face shielding block 29 with a stepped profile 30, which is configured to be complementary to the first peripheral step 26 and the second peripheral step 27 of the roller 23, such that the stepped profile 30 is engaged with the two peripheral steps 26 and 27. This results in a gap region 31 between the end face end profile of the roller 23 and the shielding block 29. In FIG. 4 this has the appearance as if the X-radiation emitted in the direction of arrow 32 might be completely shielded by the shielding block 29 and the roller 23. The cross-sectional representation of FIG. 5 shows, however, that this is not the case. In FIG. 5 the roller 23 rotatable about the axis of rotation 3 is shown in cross-section, wherein the jacket surface of the roller 23 is partly enclosed by the receptacle 7. The at least one electron emitter 8, arranged in the receptacle 7, is designed to generate electrons for irradiating the material web guided over the roller 23. On deceleration of these electrons, high-energy X-radiation arises, which is emitted inter alia in the directions 33, 34, 35 and 36 shown by dashed lines in FIG. 5. As is apparent from FIG. 5, the X-radiation may exit unimpeded from the irradiation apparatus, in particular within the radial portions of the gap region 31, i.e. along the end faces of the first peripheral step 26 and the second peripheral step 27. Because of this transmission possibility, the shielding shown in FIGS. 4 and 5 has gaps. These gaps can be prevented by the convexly outwardly curved configuration, shown in FIG. 2, of the transitional region 15 of the roller 2 and the resultant curved configuration of the gap region 20. As is apparent in particular from FIG. 2 and FIG. 3, with such a curved configuration of the gap region 20 direct passage of the X-radiation outwards through the gap region 20 is no longer possible, such that effective shielding of the X-radiation is achieved.

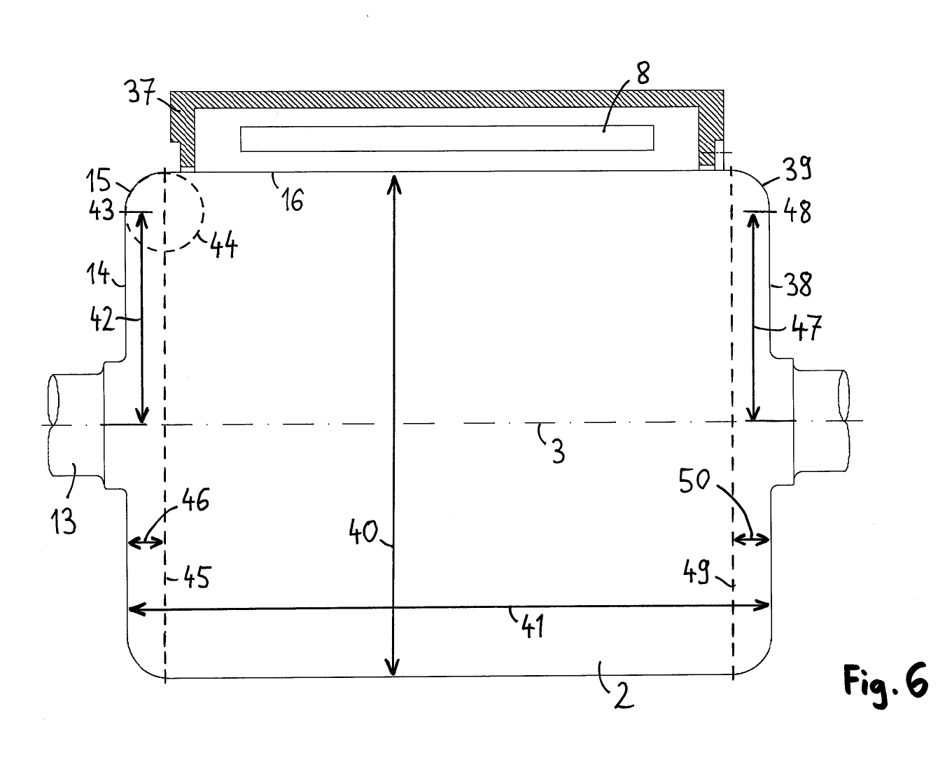

The proportions and dimensions of the roller 2 will be explained below with reference to FIG. 6. FIG. 6 shows a longitudinal section through the roller 2, which passes through the axis of rotation 3. In this case, the roller 2 may be driven in rotation about the axis of rotation 3 via the drive shaft 13. Furthermore, FIG. 6 also shows an irradiation unit 37, which comprises at least one electron emitter 8.

As has already been explained with reference to FIG. 2, the roller 2 has a first end face region 14, which is adjoined by a first curved transitional region 15. The first curved transitional region 15 forms a transition between the first end face region 14 and the jacket surface 16 of the roller 2. Viewed in the direction of the axis of rotation 3, the second end face region 38 is provided opposite the first end face region 14. The second end face region 38 is adjoined by the second curved transitional region 39, which forms the transition between the second end face region 38 and the jacket surface 16 of the roller 2. The jacket surface 16 takes the form of a jacket surface of a circular cylinder of the diameter D and is provided to guide the web material to be irradiated through the irradiation apparatus. In this case, the diameter D lies for example in the range between 15 cm and 155 cm. In FIG. 6 the diameter D of the roller 2 is represented by the double-headed arrow 40. The length L of the roller 2 extends in the axial direction from the first end face region 14 to the second end face region 38. The length L may lie, for example, in the range between 40 cm and 3.8 m. In FIG. 6 the length L is represented by the double-headed arrow 41.

The first end face region 14 of the roller 2 has a radius R₁ at its circularly peripheral edge which preferably lies in the range of between 30% and 47% of the diameter D. The radius R₁ extends as far as the circularly peripheral edge of the first end face region 14. The radius R₁ is represented in FIG. 6 by the double-headed arrow 42. The first end face region 14 therefore ends at the first radial position 43, which is adjoined by the first curved transitional region 15. In this case, the slope of the contour of the roller is continuous at the transition from the first end face region 14 to the first curved transitional region 15.

Viewed in longitudinal section, the contour of the roller 2 has a curvature at the transition from the first end face region 14 to the first curved transitional region 15, within the first curved transitional region 15 and at the transition from the first curved transitional region 15 to the jacket surface 16 which is smaller than a predetermined maximum curvature, so as to prevent the contour from having sharp corners. The curvature κ of the contour at a given point is in this case given by the reciprocal of the radius of curvature at this point: κ=1/r_{κ}, wherein r_{κ} denotes the radius of the circle of curvature. The predetermined maximum curvature κ of the contour corresponds to a minimum radius of curvature r_{κ}. In this case, the minimum radius of curvature r_{κ} preferably amounts to 5% of the diameter D. The radius of curvature at each point of the contour within the first curved transitional region 15 preferably lies above the minimum radius of curvature r_{κ}, which amounts to 5% of the diameter D. More preferably, the radius of curvature at each point of the contour within the transitional region 15 lies in the range of between 5% and 40% of the diameter D. In the example shown in FIG. 6, the curvature within the entire transitional region is constant, wherein the curvature in the entire first transitional region 15 is given by the radius of curvature of the dashed circle 44. It would however likewise be readily possible for the curvature within the transitional region 15 to vary, wherein at each point a maximum curvature must not be exceeded or a minimum radius of curvature r_{κ} must not be fallen below.

At a first axial position 45, the jacket surface 16 adjoins the first transitional region 15, wherein the slope of the contour at the transition to the jacket surface 16, and in particular at the first axial position 45, is continuous. In this respect, viewed in a longitudinal plane through the axis of rotation 3, the slope of the contour of the roller 2 is continuous at the transition from the first end face region 14 to the first curved transitional region 15, within the first curved transitional region 15 and at the transition from the first curved transitional region 15 to the jacket surface 16. In this case, the first axial position 45 is offset relative to the edge of the first end face region 14 in the axial direction by a spacing L1 towards the center of the roller 2, wherein the spacing L1 preferably amounts to between 3% and 25% of the length L. In FIG. 6 the spacing L1 of the first axial position 45 in the axial direction relative to the first end face region 14 is illustrated by double-headed arrow 46.

The course of the contour of the roller 2 at the second axial end of the roller 2 preferably corresponds to the course of the contour at the first axial end of the roller 2. Alternatively, the contour at the second axial end of the roller 2 may however also differ from the contour at the first axial end of the roller 2. The second end face region 38 preferably has a radius R₂ at its circularly peripheral edge which lies in the range of between 30% and 47% of the diameter D. In FIG. 6 the radius R₂ is represented by the double-headed arrow 47. The second end face region 38 extends only as far as the second radial position 48. There the second curved transitional region 39 adjoins the second end face region 38, wherein the slope at the transition between the second end face region 38 and the second curved transitional region 39 is continuous. At the transition from the second end face region 38 to the second transitional region 39, within the second transitional region 39 and at the transition from the second transitional region 39 to the jacket surface 16, the curvature κ is less than a maximum curvature obtained as the reciprocal of a minimum radius of curvature r_{κ}. In this case, the minimum radius of curvature r_{κ} preferably amounts to 5% of the diameter D. The curvature within the second transitional region 39 preferably lies in a range which corresponds to a radius of curvature of between 5% and 40% of the diameter D. In this case, the curvature may, as in the example shown in FIG. 6, be given at each point of the second transitional region 39 by a constant radius of curvature. The curvature may however also vary within the second transitional region 39, wherein the curvature at each point has to be less than a predetermined maximum curvature in order to prevent sharp corners over the course of the contour of the roller 2 in the second transitional region 39. At a second axial position 49 the second transitional region 39 merges into the jacket surface 16, wherein the slope at the transition between the second transitional region 39 and the jacket surface 16 is continuous. In this respect, viewed in a longitudinal plane through the center axis 3 the slope of the contour of the roller 2 at the transition from the second end face region 38 to the second curved transitional region 39, within the second curved transitional region 39 and at the transition from the second curved transitional region 39 to the jacket surface 16 is in each case continuous. The second axial position 49 is offset relative to the second end face region 38 of the roller 2 in the axial direction by a spacing L2 towards the center of the roller 2, wherein the spacing L2 preferably lies in the range of between 3% and 25% of the length L of the roller 2. In FIG. 6 the spacing L2 is shown by the double-headed arrow 50. The advantage of the shape of the roller shown in FIG. 6 is in particular that particularly effective shielding of the X-radiation arising within the receptacle 7 is enabled by the outwardly curved transitional regions 15 and 39.

Viewed in the axial direction of the roller from the center of the roller towards an end face, the diameter of the outer contour of the roller remains the same or becomes smaller. If, therefore, the outer contour of the roller is followed in the axial direction from the center of the roller towards an end face, the diameter of the outer contour of the roller remains the same or becomes smaller when viewed in the axial direction

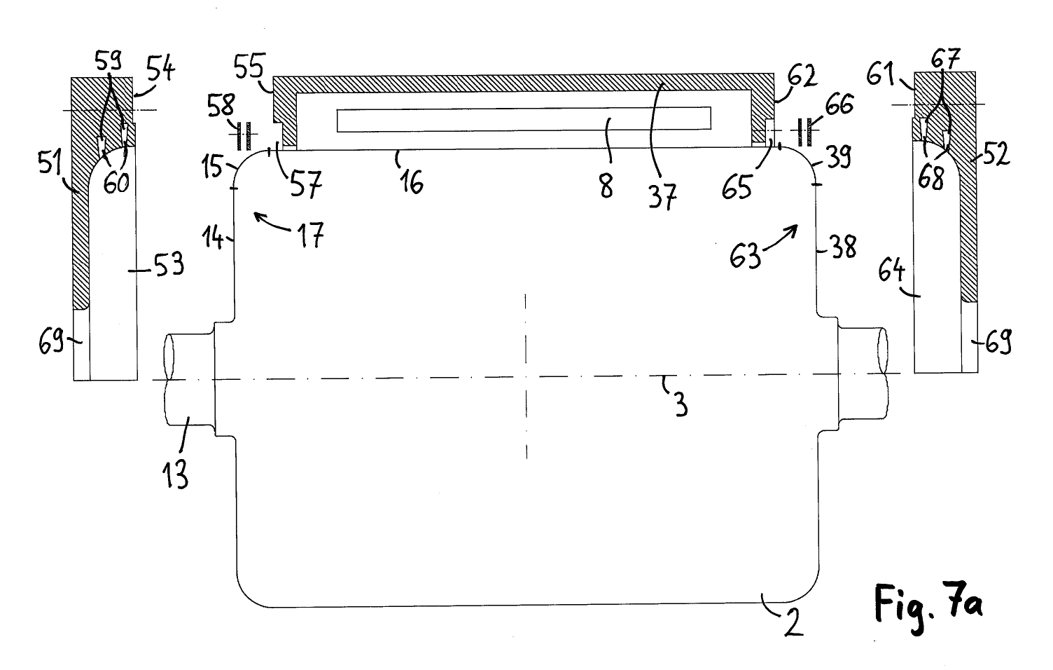

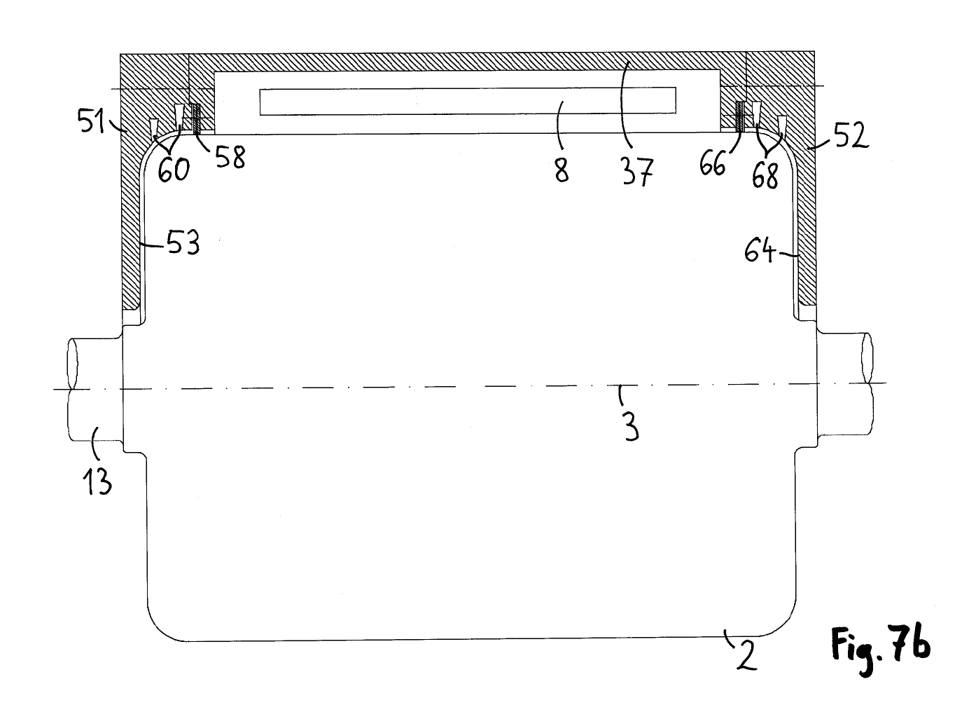

FIG. 7a shows how shielding blocks 51, 52 are each mounted detachably at the two end faces of the irradiation unit 37. The shielding blocks 51, 52 shield the arcuate gap between the irradiation unit 37 and the roller 2 at the two end faces in such a way that the X-radiation arising is actively retained.

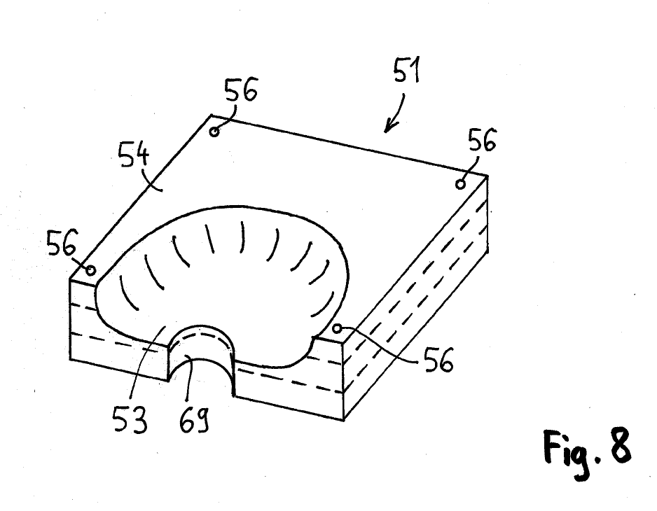

FIG. 8 shows shielding block 51 in an oblique view. It shows the depression 53, which is configured as a negative hollow shape relative to at least one part of the end face end profile 17 of the roller 2. The inner surface of the depression 53 is configured to be complementary to the end surface 14 and to the curved transitional region 15. In particular, the depression 53 has a concave peripheral curvature, which is configured to be complementary to the convexly outwardly curved transitional region 15 of the roller 2. The shielding block 51 has a bearing surface 54, which is provided for detachable fastening on the end face mounting surface 55 of the irradiation unit 37. In this case, the end face mounting surface 55 of the irradiation unit 37 preferably extends in a plane substantially perpendicular to the axis of rotation of the roller 2. As an alternative, the end face mounting surface 55 could also extend in a plane inclined obliquely relative to the center axis 3. For example, the end face mounting surface 55 could extend in a plane which is inclined by an angle of between 0° and 60° relative to a plane perpendicular to the center axis 3. In this case, the bearing surface 54 of the shielding block 51 would also extend in a plane inclined obliquely to the center axis 3. If the shielding block 51 is fastened to the end face mounting surface 55 of the irradiation unit 37, a gap region arises between the depression 53 and the end face end profile 17 of the roller 2, by which gap region the X-radiation arising is repeatedly refracted, as illustrated in FIGS. 2 and 3, and thus shielded. The gap region preferably has a substantially uniform gap width.

Detachable fastening of the shielding block 51 to the end face mounting surface 55 of the irradiation unit 37 preferably proceeds by means of fastening elements 56 provided for this purpose, for example using dowel pins, screwed joints, clamping elements or other fastening elements. The fastening elements 56 may for example be intended to fix the shielding block 51 in a position in which the bearing surface 54 rests on the end face mounting surface 55. The bearing surface 54 preferably lies flat on the end face mounting surface 55. Alternatively, the fastening elements 56 may be configured to enable adjustable positioning of the shielding block 51 relative to the irradiation unit 37, in order in this way to be able for example to adjust the gap region between the depression 53 and the end face end profile 17. In this case, adjustment of the position of the shielding block 51 relative to the irradiation unit 37 by means of the fastening elements 56 may comprise at least one of the following: positioning of the shielding block 51 in the axial direction, positioning of the shielding block 51 in a plane perpendicular or oblique to the axial direction, adjustment of the inclination of the shielding block 51 relative to a transverse plane perpendicular to the center axis 3. The shielding block 51 may in particular be positioned in such a way by means of the fastening elements 56 as to result in a desired gap region, for example a uniformly configured gap region of uniform gap width, between the depression 53 and the end face end profile 17. Additionally or alternatively, the gap width of the gap region may be adjusted by adjusting the position of the shielding block 51.

At the region of the end face mounting surface 55 facing the roller 2, a notch 57 is provided which encircles a part of the roller 2, into which notch one or more arcuate sheets 58 may be inserted. The arcuate sheets 58 inserted into the notch 57 in this case extend as far as to the surface of the roller 2 and thereby bring about a gas-tight or at least approximately gas-tight seal between the region of the roller 2 irradiated by the at least one electron emitter 8 and the gap region formed between the shielding block 51 and the end face end profile 17 of the roller 2. A vacuum may for example be generated in the gap region between the shielding block 51 and the end face end profile 17 of the roller 2. In this way, irradiation of the web with electrons may be performed under a vacuum, so improving the efficiency of the irradiation. With the gas seal shown in FIG. 7a and achieved using the arcuate sheets 58, it is for example possible to maintain a vacuum in the range from around 50 ppm to 60 ppm or even below 50 ppm. Furthermore, the electron irradiation within the irradiation unit 37 results in ozone. The gas seal prevents the ozone from leaking out. As an alternative to the production of a vacuum, a noble gas such as argon may for example be introduced into the gap region between the at least one electron emitter 8 and the jacket surface 16. In this case, the noble gas introduced may be retained in the gap region between the at least one electron emitter 8 and the jacket surface 16 by means of the arcuate sheets 58.

The arcuate sheets 58 may preferably take the form of segments of a circular ring, for example in the form of arcs covering a semicircle. In this case, an arcuate sheet may for example also be assembled from two or more adjacently arranged circular arc segments.

To improve radiation absorption, recesses 59 may be provided within the shielding block 51, into which recesses inserts 60 of radiation-absorbing material may be inserted. Alternatively, molten shielding material, for example molten lead, could for example be introduced into the recesses 59. The inserts 60 allow a small quantity of radiation-absorbing material to produce efficient additional radiation shielding, which in particular absorbs the radiation exiting from the arcuate gap between the irradiation unit 37 and the roller 2. As illustrated in FIG. 8 by the dashed lines, the shielding block 51 could for example be constructed from a plurality of plates arranged one above the other, which each have depressions for inserts of radiation-absorbing material. With such a shielding block 51 structure consisting of a plurality of plates, the depressions may be configured for the inserts at or in the bearing surfaces of the plates, such that the inserts of radiation-absorbing material are located within the shielding block 51.

In FIG. 7a the second shielding block 52 is mounted detachably on the second end face of the irradiation unit 37, wherein the bearing surface 61 of the second shielding block 52 may be fastened detachably to the end face mounting surface 62 of the irradiation unit 37. In this case, the second end face end profile 63 extends into the depression 64 of the second shielding block 52 and is enclosed at least in part by the depression 64. At the end face mounting surface 62 of the irradiation unit 37, a notch 65 encircling part of the roller 2 is likewise provided into which arcuate sheets 66 may be inserted for the purpose of gas sealing. Like the first shielding block 51, the second shielding block 52 also has recesses 67, into which inserts 68 of radiation-shielding material, such as for example lead, may be inserted.

FIG. 7b shows the irradiation apparatus in the assembled state, wherein the shielding block 51 is fastened detachably by its bearing surface 54 to the end face mounting surface 55 of the irradiation unit 37 and wherein the shielding block 52 is fastened detachably by its bearing surface 64 to the end face mounting surface 62. In the example shown in FIGS. 7a and 7b, the shielding blocks 51, 52 extend from the at least one electron emitter 8 to the axis of rotation 3, wherein recesses 69 for the drive shaft 13 are provided in each of the shielding blocks 51, 52. Viewed in the direction of the axis of rotation 3, the shielding block 51 preferably covers at least 30%, more preferably at least 40%, more preferably at least 50%, more preferably at least 55%, more preferably at least 60% of the end surface or cross-sectional area of the roller 2. The shielding block 51 preferably covers less than 80%, more preferably less than 70%, more preferably less than 65% of the end surface or cross-sectional area of the roller 2. In this way, effective shielding of the X-radiation is achieved, wherein the accessibility of the roller 2 in the open roller arrangement is further ensured.

The features disclosed in the above description, the claims and the drawings may be of significance for implementation of the invention in its various embodiments either individually or in any desired combination.

1. A roller for an irradiation apparatus, wherein the roller is designed to guide a material web to be irradiated past at least one electron emitter,
wherein the roller has:
a first end face region of the roller, wherein the diameter of the first end face region is smaller than the diameter of the roller,
a jacket surface of the roller, which takes the form of a jacket surface of a right circular cylinder,
wherein the jacket surface extends in the axial direction from a first axial position to a second axial position of the roller, wherein the first axial position has an axial spacing from the edge of the first end face region which amounts to between 3% and 25% of the length of the roller, and wherein the second axial position is further away from the first end face region than the first axial position,
characterized in that
the roller has a first curved transitional region, which extends from the edge of the first end face region annularly and continuously as far as the first axial position of the roller,
wherein, viewed in a longitudinal plane through the center axis of the roller, a curvature of the contour of the roller at the transition from the first end face region to the first curved transitional region, within the first curved transitional region and at the transition from the first curved transitional region to the jacket surface is in each case less than a maximum curvature which corresponds to a minimum radius of curvature of 5% of the diameter of the roller.

2. The roller as claimed in claim 1, characterized in that, viewed in a longitudinal plane through the center axis of the roller, a slope of the contour of the roller at the transition from the first end face region to the first curved transitional region, within the first curved transitional region and at the transition from the first curved transitional region to the jacket surface is in each case continuous.

3. The roller as claimed in claim 1, characterized by at least one of the following:
viewed in a longitudinal plane through the center axis of the roller, a slope of the contour of the roller at the transition from the first end face region to the first curved transitional region, within the first curved transitional region and at the transition from the first curved transitional region to the jacket surface in each case falls monotonically or rises monotonically;
viewed in a longitudinal plane through the center axis of the roller, the sign of the curvature of the contour of the roller at the transition from the first end face region to the first curved transitional region, within the first curved transitional region and at the transition from the first curved transitional region to the jacket surface remains unchanged;
viewed in a longitudinal plane through the center axis of the roller, the contour of the roller within the first curved transitional region has a curvature at each point of the contour which corresponds to a radius of curvature in the range between 5% and 40% of the diameter of the jacket surface of the roller;
viewed in a longitudinal plane through the center axis of the roller, a curvature of the contour of the roller at the transition from the first end face region to the first curved transitional region, within the first curved transitional region and at the transition from the first curved transitional region to the jacket surface is at each point of the contour less than a maximum curvature which is equal to the reciprocal of a radius of curvature of 5% of the diameter of the jacket surface of the roller;
viewed in a longitudinal plane through the center axis of the roller, the contour of the roller within the first curved transitional region has a curvature at each point of the contour which lies within a range which is given by reciprocals of the radius of curvature in the range from 5% to 40% of the diameter of the jacket surface of the roller;
the curvature within the first transitional region is given by a single radius of curvature, wherein this radius of curvature lies in the range between 5% and 40% of the diameter of the jacket surface of the roller;
the curvature extends continuously within the first curved transitional region.

4. The roller as claimed in claim 1, characterized in that the roller has a second end face region which, when viewed in the axial direction, is arranged opposite the first end face region,
wherein the second end face region of the roller has a diameter which is smaller than the diameter of the roller,
wherein the second axial position of the roller has an axial spacing from the edge of the second end face region which amounts to between 5% and 25% of the length of the roller,
wherein the roller has a second curved transitional region, which extends from the edge of the second end face region annularly and continuously as far as the second axial position of the jacket surface,
wherein, viewed in a longitudinal plane through the center axis of the roller, a slope of a contour of the roller at the transition from the second end face region to the second curved transitional region, within the second curved transitional region and at the transition from the second curved transitional region to the jacket surface is in each case continuous, and
viewed in a longitudinal plane through the center axis of the roller, a curvature of the contour of the roller within the second curved transitional region is smaller at each point of the contour than a maximum curvature which corresponds to a minimum radius of curvature of 5% of the diameter of the roller.

5. The roller as claimed in claim 1, characterized by at least one of the following:
the first end face region is configured to be rotationally symmetrical relative to the center axis of the roller;
the second end face region is configured to be rotationally symmetrical relative to the center axis of the roller;
the first end face region takes the form of the first end surface of the roller, which is perpendicular to the center axis of the roller;
the second end face region takes the form of the second end surface of the roller, which is perpendicular to the center axis of the roller;
the center axis of the roller takes the form of the axis of rotation of the roller;
the first curved transitional region is configured to be rotationally symmetrical relative to a center axis of the roller;
the first curved transitional region is configured as a convexly outwardly curved transitional region;
the first curved transitional region is an annularly peripheral, convexly outwardly curved transitional region;
the first end face region has a radius which amounts to between 30% and 47% of the diameter of the roller;
the second end face region has a radius which amounts to between 30% and 47% of the diameter of the roller;
the roller takes the form of a rotationally symmetrical component;
the roller is configured to be rotationally symmetrical about an axis of rotation of the roller;
the roller is a cooling roll for an electron irradiation apparatus;
the roller is a web guide roller;
the roller is a web guide roller for an electron irradiation apparatus;
radiation shielding of radiation-shielding material is arranged at the jacket surface or within the jacket surface for the purpose of shielding from high-energy radiation;
radiation shielding in the form of a cylinder jacket of radiation-shielding material is arranged at the jacket surface or within the jacket surface for the purpose of shielding from high-energy radiation.

6. The roller as claimed in claim 1, characterized by at least one of the following:
the jacket surface of the roller has a diameter of more than 15 cm;
the jacket surface of the roller has a diameter of less than 155 cm;
the roller has a length of between 40 cm and 3.80 m from the first end face region to the second end face region;
the roller is designed to guide material webs with a width of between 15 cm and 3.50 m;
the jacket surface of the roller has a length of between 20 cm and 3.60 m.

7. An irradiation apparatus for irradiating a material web with electrons, having:
a rotatably mounted roller as claimed in claim 1 for guiding a material web to be irradiated,
an irradiation unit with a receptacle which extends in the longitudinal direction of the roller and is designed to enclose a sub-portion of the roller, wherein at least one electron emitter is arranged within the receptacle which is designed to irradiate with electrons a material web guidable over the roller.

8. The irradiation apparatus as claimed in claim 7, characterized by at least one of the following:
an inner wall of the receptacle facing the roller follows the course, at least in a sub-region, of the first curved transitional region of the roller;
an inner wall of the receptacle facing the roller follows the course, at least in a sub-region, of the first curved transitional region of the roller, wherein a gap region is formed between the inner wall of the receptacle and the first curved transitional region;
an inner wall of the receptacle facing the roller follows the course, at least in a sub-region, of the first curved transitional region of the roller, wherein a gap region is formed between the inner wall of the receptacle and the first curved transitional region, wherein the gap region is dimensioned so as to achieve effective radiation shielding;
an inner wall of the receptacle facing the roller has a shape, at least in a sub-region, complementary to the first curved transitional region of the roller;
the first curved transitional region of the roller is surrounded at least in part by the receptacle, which has a shape, at least in a sub-region, complementary to the first curved transitional region;
at least one sub-region of the receptacle is configured as a negative hollow shape relative to at least one sub-region of the first curved transitional region of the roller.

9. The irradiation apparatus as claimed in claim 7, characterized in that the roller has a first end face end profile at the first axial end of the roller which encompasses the first end face region and the first curved transitional region.

10. The irradiation apparatus as claimed in claim 9, characterized by at least one of the following:
an inner wall of the receptacle facing the roller follows the course, at least in a sub-region, of the first end face end profile of the roller;
an inner wall of the receptacle facing the roller follows the course, at least in a sub-region, of the first end face end profile of the roller, wherein a gap region is formed between the inner wall of the receptacle and the first end face end profile of the roller;
an inner wall of the receptacle facing the roller follows the course, at least in a sub-region, of the first end face end profile of the roller, wherein a gap region is formed between the inner wall of the receptacle and the first end face end profile of the roller, wherein the gap region is dimensioned so as to achieve effective radiation shielding;
an inner wall of the receptacle facing the roller has a shape, at least in a sub-region, complementary to the first end face end profile of the roller;
the first end face end profile is enclosed at least in part by the complementarily shaped receptacle;
the first end face end profile of the roller is enclosed at least in part by the receptacle which has a shape, at least in a sub-region, complementary to the first end face end profile;
at least one sub-region of an inner wall of the receptacle facing the roller is configured as a negative hollow shape relative to at least one sub-region of the first end face end profile of the roller.

11. The irradiation apparatus as claimed in claim 7, characterized by at least one of the following:
the receptacle has an arcuate profile transversely of the center axis of the roller, wherein the arcuate profile of the receptacle is designed to enclose a sub-portion of the roller;
the at least one electron emitter extends in the axial direction along a region of the receptacle facing the roller;
the receptacle is a concavely shaped receptacle;
the roller is mounted rotatably about a center axis, which takes the form of the axis of rotation;
radiation shielding surrounding the at least one electron emitter is provided within the irradiation unit;
at least one mounting surface of the irradiation unit extends substantially in a plane perpendicular to the center axis of the roller.

12. The irradiation apparatus as claimed in claim 7, characterized in that the irradiation apparatus comprises a shielding block for radiation shielding, wherein the shielding block has:
a bearing surface, via which the shielding block may be detachably fastened to a mounting surface of the irradiation unit,
a depression provided in the shielding block, wherein at least one sub-region of the depression is configured as a negative hollow shape relative to at least one sub-region of the first curved transitional region of the roller.

13. An irradiation apparatus for irradiating a material web with electrons, having:
a rotatably mounted roller for guiding a material web to be irradiated,
wherein the roller comprises a first end face end profile at a first axial end of the roller and a jacket surface, wherein the jacket surface of the roller takes the form of a jacket surface of a right circular cylinder and extends from the first end face end profile in the axial direction of the roller,
an irradiation unit with a receptacle, wherein the receptacle extends in the longitudinal direction of the roller and is designed to enclose a sub-portion of the roller, wherein at least one electron emitter is arranged within the receptacle which is designed to irradiate with electrons a material web guidable over the roller,
characterized in that
the first end face end profile of the roller comprises a convexly curved region,
wherein the irradiation apparatus comprises a shielding block for radiation shielding, wherein the shielding block has:
a bearing surface, via which the shielding block may be detachably fastened to a mounting surface of the irradiation unit,
a depression provided in the shielding block, wherein at least one sub-region of the depression is configured as a negative hollow shape relative to at least one sub-region of the convexly curved region.

14. The irradiation apparatus as claimed in claim 13, characterized by at least one of the following:
the depression follows the course, at least in a sub-region, of the convexly curved region;
the depression follows the course, at least in a sub-region, of the convexly curved region, wherein a gap region is formed between the depression and the convexly curved region;
the depression follows the course, at least in a sub-region, of the convexly curved region, wherein a gap region is formed between the depression and the convexly curved region, wherein the gap region is dimensioned so as to achieve effective radiation shielding;
the depression has a shape, at least in a sub-region, complementary to the convexly curved region;
the convexly curved region is surrounded at least in part by the depression, which has a shape, at least in a sub-region, complementary to the convexly curved region;
the depression is designed to enclose the first end face end profile of the roller at least in part when the shielding block is fastened to the mounting surface.

15. The irradiation apparatus as claimed in claim 13, characterized by at least one of the following:
the depression follows the course, at least in a sub-region, of the first end face end profile of the roller;
the depression follows the course, at least in a sub-region, of the first end face end profile of the roller, wherein a gap region is formed between the inner wall of the depression and the first end face end profile of the roller;
the depression follows the course, at least in a sub-region, of the first end face end profile of the roller, wherein a gap region is formed between the inner wall of the depression and the first end face end profile of the roller, wherein the gap region is dimensioned so as to achieve effective radiation shielding;
the depression follows the course, at least in a sub-region, of the first end face end profile of the roller, wherein a gap region is formed between the inner wall of the depression and the first end face end profile of the roller, wherein the gap region has a substantially uniform gap width;
the depression has a shape, at least in a sub-region, complementary to the first end face end profile of the roller;
the depression is configured as a negative hollow shape relative to at least one sub-region of the first end face end profile of the roller;
the first end face end profile of the roller is enclosed at least in part by the complementarily shaped depression when the shielding block is fastened to the mounting surface;
the depression is designed to accommodate at least one part of the first end face end profile of the roller when the shielding block is fastened to the mounting surface;
the depression is configured such that, when the shielding block is fastened to the mounting surface, at least one part of the first end face end profile of the roller extends into the depression;
the irradiation apparatus has at least one further shielding block.

16. The irradiation apparatus as claimed in claim 13, characterized by at least one of the following:
the first end face end profile of the roller has a rotationally symmetrically shaped outer surface;
the first end face end profile of the roller is of rotationally symmetrical configuration;
the convexly curved region is an annularly peripheral, convexly outwardly curved region of the first end face end profile;
the convexly curved region is an annularly peripheral, convexly outwardly curved region of the first end face end profile which is rotationally symmetrical relative to the axis of rotation of the roller;
the first end face end profile comprises the convexly curved region and a first end face region of the roller;
the first end face end profile comprises the convexly curved region and a first end face region of the roller, wherein the convexly curved region forms a transition from the first end face region of the roller to the jacket surface of the roller.

17. The irradiation apparatus as claimed in claim 13, characterized in that, in the axial direction opposite the first end face end profile, a second end face end profile is arranged at a second axial end of the roller and the jacket surface of the roller extends axially from the first end face end profile to the second end face end profile.

18. The irradiation apparatus as claimed in claim 13, characterized in that the roller has:
a first end face region of the roller, wherein the diameter of the first end face region is smaller than the diameter of the roller,
the jacket surface of the roller, wherein the jacket surface extends in the axial direction from a first axial position to a second axial position of the roller, wherein the first axial position has an axial spacing from the edge of the first end face region which amounts to between 3% and 25% of the length of the roller, and wherein the second axial position is further away from the first end face region than the first axial position, and
a first curved transitional region, which extends from the edge of the first end face region annularly and continuously as far as the first axial position of the roller,
wherein, viewed in a longitudinal plane through the center axis of the roller, a curvature of the contour of the roller at the transition from the first end face region to the first curved transitional region, within the first curved transitional region and at the transition from the first curved transitional region to the jacket surface is in each case less than a maximum curvature which corresponds to a minimum radius of curvature of 5% of the diameter of the roller.

19. The irradiation apparatus as claimed in claim 13, characterized by at least one of the following:
the irradiation apparatus comprises a roller frame, in which the roller is rotatably mounted;
the irradiation apparatus comprises a roller frame, in which the roller is rotatably mounted, wherein the roller frame with the roller and the irradiation unit are movable relative to one another;
the irradiation apparatus comprises a roller frame, in which the roller is rotatably mounted, wherein the roller frame with the roller and the irradiation unit are movable relative to one another, wherein the irradiation unit is movable relative to the roller frame into an open position and into a closed position, wherein in the closed position the at least one electron emitter is positioned in such a way relative to the roller that a material web guided over the roller may be irradiated, and wherein in the open position access is enabled to the roller.

20. The irradiation apparatus as claimed in claim 13, characterized by at least one of the following:
a notch encircling part of the roller is formed on a mounting surface of the irradiation unit at the region facing the roller;
a notch encircling part of the roller is formed on a mounting surface of the irradiation unit at the region facing the roller, wherein one or more arcuate sheets may be inserted into the notch;
a notch encircling part of the roller is formed on a mounting surface of the irradiation unit at the region facing the roller, wherein a stack of multiple arcuate sheets may be inserted one above the other into the notch;
a notch encircling part of the roller is formed on a mounting surface of the irradiation unit at the region facing the roller, wherein one or more arcuate sheets may be inserted into the notch, wherein the one or more arcuate sheets are configured to provide a gas seal between the irradiation unit and the roller.

21. The irradiation apparatus as claimed in claim 13, characterized by at least one of the following:
the shielding block is formed at least in part from a radiation-shielding material;
shielding inserts made of a shielding material are arranged within the shielding block;
recesses extend from the depression of the shielding block into the interior of the shielding block, into which recesses shielding inserts of a shielding material may be inserted or into which molten shielding material may be introduced;
the shielding block is constructed from a plurality of axially successive plate elements, wherein at least one plate element has one or more recesses for one or more shielding inserts.

22. The irradiation apparatus as claimed in claim 13, characterized by at least one of the following:
the mounting surface of the irradiation unit extends substantially in a plane which is inclined by an angle of between 0° and 60° relative to a plane perpendicular to the center axis of the roller;
the mounting surface of the irradiation unit extends substantially in a plane perpendicular to the center axis of the roller;
when the shielding block is fastened to the mounting surface of the irradiation unit, the bearing surface of the shielding block extends in the direction predetermined by the mounting surface of the irradiation unit;
when the shielding block is fastened to the mounting surface of the irradiation unit, the bearing surface of the shielding block extends in a plane perpendicular to the center axis of the roller.

23. The irradiation apparatus as claimed in claim 13, characterized by at least one of the following:
viewed in the direction of the center axis of the roller, the shielding block covers at least part of the cross-section of the roller;
viewed in the direction of the center axis of the roller, the shielding block covers at least 30% of the cross-section of the roller;
viewed in the direction of the center axis of the roller, the shielding block covers at least 50% of the cross-section of the roller;
viewed in the direction of the center axis of the roller, the shielding block covers a gap between the roller and the receptacle of the irradiation unit;
the shielding block is fastenable detachably by means of fastening elements to a mounting surface of the irradiation unit;
the shielding block is fastenable detachably by means of fastening elements to a mounting surface of the irradiation unit, wherein a spacing between the first end face end profile of the roller and the inner wall of the depression is adjustable by means of the fastening elements;
the shielding block is fastenable detachably by means of fastening elements to a mounting surface of the irradiation unit, wherein the position of the shielding block relative to the mounting surface is adjustable by means of the fastening elements.

24. An irradiation apparatus for irradiating a material web with electrons, having:
a rotatably mounted roller for guiding a material web to be irradiated,
wherein the roller comprises a first end face end profile at a first axial end of the roller and a jacket surface, wherein the jacket surface of the roller takes the form of a jacket surface of a right circular cylinder and extends from the first end face end profile in the axial direction of the roller,
an irradiation unit with a receptacle, wherein the receptacle extends in the longitudinal direction of the roller and is designed to enclose a sub-portion of the roller, wherein at least one electron emitter is arranged within the receptacle which is designed to irradiate with electrons a material web guidable over the roller,
characterized in that
the irradiation apparatus comprises a shielding block for radiation shielding, wherein the shielding block has:
a bearing surface, via which the shielding block may be detachably fastened to a mounting surface of the irradiation unit,
a depression provided in the shielding block, which is designed to enclose the first end face end profile of the roller at least in part when the shielding block is fastened to the mounting surface, wherein the shielding block covers at least 30% of the cross-section of the roller when viewed in the direction of the center axis of the roller.

25. A method for providing radiation shielding in an irradiation apparatus, wherein the irradiation apparatus has:
a rotatably mounted roller for guiding a material web to be irradiated,
wherein the roller comprises a first end face end profile at a first axial end of the roller and a jacket surface, wherein the first end face end profile comprises a convexly curved region,
wherein the jacket surface of the roller takes the form of a jacket surface of a right circular cylinder and extends from the first end face end profile in the axial direction of the roller,
an irradiation unit with a receptacle, wherein the receptacle extends in the longitudinal direction of the roller and is designed to enclose a sub-portion of the roller, wherein at least one electron emitter is arranged within the receptacle which is designed to irradiate with electrons a material web guidable over the roller,
a shielding block for radiation shielding, wherein the shielding block has:
a bearing surface, via which the shielding block may be detachably fastened to a mounting surface of the irradiation unit, and
a depression provided in the shielding block,
wherein the method has the following step:
mounting the shielding block on a mounting surface of the irradiation unit in such a manner that at least one part of the first end face end profile of the roller extends into the depression of the shielding block, wherein at least one sub-region of the depression takes the form of a negative hollow shape relative to at least one sub-region of the convexly curved region.
